(19) United States
(12) Patent Application Publication
(10) Pub. No.: US 2005/0287276 A1
(43) Pub. Date: Dec. 29, 2005

(54) Microencapsulation for sustained delivery of carbon dioxide

(75) Inventors: Adrien R. Lavoie, Beaverton, OR (US); David S. Soane, Chestnut Hill, MA (US)

Correspondence Address: JACQUELINE S LARSON, 245 AVINGTON ROAD, ALAMEDA, CA, 94502, US

(73) Assignee: DuraFizz, LLC

(21) Appl. No.: 11/185,071

(22) Filed: Jul. 19, 2005

Related U.S. Application Data
(63) Continuation of application No. PCT/US04/01628, filed on Jan. 22, 2004.
(60) Provisional application No. 60/441,688, filed on Jan. 22, 2003.

(51) Int. Cl. C12C 1/00

(52) U.S. Cl. 426/590

(57) ABSTRACT

The present invention relates to solid delivery systems for storage, distribution, and delivery of carbon dioxide into beverages. More specifically, this invention is directed to methods and preparations for providing a powdered beverage formulation capable of sustained carbonation in aqueous solution and to methods for carbonating a beverage that sustainably releases carbon dioxide into the beverage.

This application is a continuation application of International Patent Appln. No. PCT/US2004/001628, filed on Jan. 22, 2004 and designating the United States, which International application claims the benefit of U.S. Provisional patent application Ser. No. 60/441,688, filed on Jan. 22, 2003, the entire disclosures of which are incorporated herein by reference.

### FIELD OF THE INVENTION

The present invention relates generally to solid delivery systems for storage, distribution, and sustained delivery of carbon dioxide into beverages.

### BACKGROUND OF THE INVENTION

Historically, the carbonation of beverages has been achieved via the pressurization of a solution with carbon dioxide (CO₂) and storage in a sealed vessel. For common carbonated beverages, typically 90-99% of the mass in a carbonated beverage is water. As a result, the end-consumer cost is largely for transportation and storage (shelf space) of the contained water. Alternatively, it would seem that the addition of water to a powdered formulation immediately preceding consumption would lead to the most economical and, at times, most convenient scenario.

The controlled and sustained delivery of gaseous carbon dioxide via the use of powdered formulations has remained an elusive goal despite numerous attempts. Early dry carbonated beverage formulations focused on the use of bicarbonates of sodium, potassium, and ammonium (Diller et al., U.S. Pat. No. 2,851,359). However, Stahl has acknowledged that the reaction of these bicarbonates with acids (thus liberating CO₂) generates byproduct salts that have an “undesirable brackish taste . . . thereby diminishing the palatability of the beverage” (Stahl, U.S. Pat. No. 3,965,273).

Various other formulations or contraptions for the controlled and sustained delivery of CO₂ from dry formulations have been patented. For example, PepsiCo. Inc. has patented an elaborate container that has an arrangement for carbonating a beverage over an extended period of time through the addition of water or beverage liquid base to a powdered or dry carbonate and acid located in a pressure chamber (Buchel, U.S. Pat. No. 4,186,215). In addition, the Coca-Cola Company has patented a method to retain carbonation in a carbonated beverage via the addition of carbonic acid ester that undergoes hydrolysis under acidic conditions to release CO₂ (Rule, U.S. Pat. No. 5,855,942).

Attempts to generate sustained CO₂ evolution via powdered formulations have been recorded (Lavie, U.S. Pat. No. 4,579,742; Lavie, U.S. Pat. No. 4,769,244; Lavie, U.S. Pat. No. 4,716,046; Feldman et al., U.S. Pat. No. 3,441,417, Schapiro et al., U.S. Pat. No. 2,868,646; Pelc, U.S. Pat. No. 1,450,865; Stanish, U.S. Pat. No. 3,061,445; Hornyak, et al., U.S. Pat. No. 3,939,289; Kuypers, U.S. Pat. No. 4,746,527.

Carbonating and effervescent formulations have previously been marketed either in tablet or powdered forms. The use of tablets, as opposed to powders, has distinct advantages for producing continuous CO₂ evolution given that the rate of dissolution is proportional to the surface area. Perhaps the most well-known effervescent tablet is commonly referred to as Alka-Seltzer®. As with most tablets, a time-release function is inherent given that the inner materials are only exposed as the most outer materials are dissolved. However, these tablets have disadvantages including their non-immediate usability and the quick onset of “flatness” following dissolution.

Several powder-form carbonated beverage additives have been marketed, including Naturade® and Emergen-C®. Upon dissolution, these CO₂-generating salt formulations (typically a selected mixture of sodium or potassium carbonates or bicarbonates combined with ascorbic acid, aspartic acid, tartaric acid, citric acid or related acids) are quickly dissolved and evolve CO₂. However, prolonged CO₂ evolution is not observed.

Signorino (U.S. Pat. No. 6,620,431) has reported on the composition and methods for the production of shellac film coatings for controlled release applications. In particular, these materials were proposed as pH controlled release vehicles for enteric or colonic delivery of the contents. Special attention was paid to the formulation of various shellacs of predetermined acid number. These coating examples were primarily 50% or greater of the resin system and were formed from water.

### SUMMARY OF THE INVENTION

The present invention relates generally to solid delivery systems for storage, distribution, and delivery of carbon dioxide into beverages. More specifically, this invention is directed to methods and preparations for providing a powdered beverage composition capable of sustained carbonation in an aqueous environment and to methods for carbonating a beverage that sustainably releases carbon dioxide into the beverage.

In one embodiment, the invention is directed to a beverage formulation that includes a microcapsule or microparticle comprising a core coated with a permeable encapsulation barrier. The core comprises an acid, a base, effervescent couples such as a mixture of both an acid and a base, or combinations thereof, and it may optionally include compounds or formulations that are precursors to the generation of CO₂. The encapsulation barrier coating comprises an organic, edible polymeric material that is insoluble and is optionally swellable in water. By “swell” or “swellable” or “to swell” or “swelling” it is meant that the barrier absorbs water without dissolving. This “swelling” may or may not lead to barrier expansion or increased water permeability. The encapsulation barrier may optionally include water-soluble additives, which serve as leachable excipients when the microcapsule is placed in an aqueous environment, thus producing nano-channels and a method for controlling the permeability of the microcapsule's barrier coating. Control and modulation of the barrier's permeability results in the sustained delivery of carbon dioxide.

The microencapsulation method of the invention is based on the slow addition, preferably by titration, of a nonsolvent to a mixture of a core material and an organic polymer (encapsulation material) in a suitable solvent. This protocol leads to the slow, controlled, and even deposition of the encapsulation material onto the core material of choice. As used herein and in the appended claims, “solvent” refers to any material in which the encapsulation material is soluble. As used herein and in the appended claims, “nonsolvent” refers to any material (i) in which the desired core material may be suspended or is weakly soluble and (ii) in which the encapsulation material is weakly or completely insoluble. The term “insoluble”, as used herein and in the appended claims, refers to agents that are water-insoluble or poorly water-soluble, generally having a solubility in water of less than 1 mg/mL. The term “weakly soluble”, as used herein and in the appended claims, generally refers to materials with a solubility in water of less than 10 mg/mL.

The present invention provides methods for the microencapsulation of acids, bases, effervescent couples, and/or combinations of these components. When microcapsules generated with these methods are reacted in an aqueous environment, such as a beverage, a sustained release of CO₂ is observed. Four general strategies for the sustained delivery of CO₂ into an aqueous solution are encompassed by the present invention. They are:
(i) delivery of a base from a microcapsule into a solution of acid,
(ii) delivery of an acid from a microcapsule into a solution of base,
(iii) tandem delivery of both an acid and a base from the same microcapsule, or
(iv) coincident delivery of acid and base from separate microcapsules.

The methods of the invention are particularly effective for applications in which reproducible microparticle coatings are required without the use of expensive mechanical equipment.

### DETAILED DESCRIPTION OF THE INVENTION

As used herein and in the appended claims, “a” and “an” mean one or more, unless otherwise indicated.

The terms “microcapsule” and “microparticle” are used interchangeably herein and in the appended claims.

The microcapsules or microparticles of the present invention comprise cores of acids, bases, effervescent couples, and/or combinations of these components. The core is coated with an encapsulation barrier that comprises a water-insoluble, optionally water-swellable edible organic polymer and, optionally, water-soluble additives. The microcapsules may include other additives as well, such as, but not limited to, compounds or formulations that are precursors to the generation of CO₂, sweeteners, flavorings, calcium phosphate, coloring agents, surfactants, dispersants, aroma additives, plasticizers, hydrating agents, texture-modifying agents, preservatives, and the like. The encapsulation barrier is “permeable”; that is, it should have a permeability that is suitable to allow the passage of water, base, acid, carbon dioxide, and any other water-soluble components in the core that one wishes to pass into the aqueous environment or, alternatively, from the aqueous environment into the core. While wishing not to be bound by the rate of CO₂ evolution or by a measure of barrier permeability, the permeability should allow for prolonged generation of CO₂ of at least about 15 minutes, preferably for at least about 30 minutes, and more preferably for at least about 1 hour.

While not wishing to be bound by theory, it is believed that the sustained evolution of CO₂ may result as a function of at least two different mechanisms. One possibility is that the permeable microcapsules release their core components into the aqueous phase, where the materials are allowed to react and CO₂ is generated. Another possibility is that a permeable encapsulation barrier allows the dissolved aqueous components to flow into the microcapsule core, leading to subsequent reaction. On reaction, CO₂ is generated and this rapid increase in volume expunges the gas from the microcapsule and into the aqueous phase. In reality, it would seem that both of these mechanisms may exist to some extent.

Examples of active basic ingredients useful in the core material include, but are not limited to: carbonates and bicarbonates of the alkali metals and the alkaline earth metals including but not limited to sodium carbonate, calcium carbonate, potassium bicarbonate, potassium carbonate, sodium hydrogen phosphate, sodium carboxy glycine (Mono SGC), sodium glycine carbonate (Di SGC), and the various hydrates of all the above.

Examples of active acidic ingredients useful in the core material include, but are not limited to: citric, malic, fumaric, adipic, aspartic, ascorbic, tartaric acid, and the various hydrates of all the above.

The encapsulation material forming the encapsulation barrier is an edible polymeric material and may be selected from, for example, polymers; resins; carbohydrates; modified carbohydrates; mono-, di-, oligo- or poly-saccharides; starches; modified starches; proteins; fatty acids; polyglycerol fatty acid esters; acrylics; vegetable gums; polyvinyl acetate; polyvinylpyrrolidone; poly(1-vinylpyrrolidone-co-vinyl acetate); povidone; crospovidone; Kollidon® polymers; Kollidon®-CL; Kollidon®-25; Kollidon®-30; Kollidon®-90; Kollidon®-12 PF; Kollidon®-17 PF; Kollidon®-VA 64; Aquacoat® aqueous dispersions; halocarbons; Aquateric® enteric coatings; hydrocarbon resins; polyvinyl alcohol; cellulose acetate; hydroxyl propyl cellulose (HPC); polyvinyl chloride; cellulose acetate butyrate; hydroxy propyl methyl cellulose (HPMC); polyvinylacetate phthalate; cellulose acetate phthalate; hydroxy propyl methyl cellulose phthalate; polyvinylidene chloride; caseinates; Kynar® fluoroplastics; chlorinated rubber; maltodextrins; rubber; synthetic; Coateric® coatings; Opaglos® coating systems; Opaglos®-GS-2-0400; Opaglos®-GS-2-0450; Opaglos®-GS-2-0700; Opaglos®-GS-2-0750; Opadry®; alkyl celluloses such as methyl cellulose and ethyl cellulose; shellac; coating butters; microcrystalline wax; silicone; Daran® latex; milk solids; dextrins; molasses; stearines; nylon; sucrose; enterics; surfactants; Eudragits® polymethacrylates; paraffin wax; Surelease® coating systems; ethylene vinyl acetate; phenolics; Teflon® fluorocarbons; fats; polylactides; polyglycolides; waxes; amino acids; polyamino acids; zein; Aqua-Zein®; gelatin; polyethylene; polyethyleneoxide; glycerides; polyethylene glycol; whey protein isolate; or combinations thereof.

Examples of encapsulation materials or water-soluble additives to the encapsulation coating include, but are not limited to: dextrose, dextrin, gum arabic, guar gum, maltose, sucrose, pectin, hydroxyl propyl cellulose (HPC), hydroxypropyl methyl cellulose (HPMC), methylcellulose, Eudragit® polymers (polyacrylates and methyacrylic acid-ethyl acrylate copolymers), Carbowax™ Sentry™ polyethylene glycol (e.g., PEG-8000), Sentry™ Polyox™ WSR N12K-NF Grade, Sentry™ Polyox™ WSR 301-NF Grade, water-soluble shellacs (preferably refined food-grade confectioners glaze), starch, modified starches, sodium chloride, alanine, arginine, asparagines, aspartic acid, cysteine, glutamine, glutamic acid, glycine, histidine, isoleucine, leucine, lysine, methionine, phenylalanine, proline, serine, threonine, tryptophan, tyrosine, valine, guar gum, sugars, sweeteners, lecithin, sodium dodecyl sulfate, Tween-20, Tween-60, Tween-85, Lutrol® systems, sodium phosphate monobasic, tartaric acid, aspartic acid, ascorbic acid, castor oil, vegetable oils, fatty acids, and glyceryl monostearate.

Examples of sweeteners include, but are not limited to: sucrose, L-aspartyl-L-phenylalanine methyl ester, sorbitol, xylitol, and mannitol, fructose, molasses, beet sugar, brown sugar, cane sugar, confectioner's sugar, powdered sugar, raw sugar, turbinado, maple syrup, carob powder, corn syrup, sugar cane syrup, honey, sweetened condensed milk, and chocolate, saccharin, aspartame, acesulfame potassium, sucralose, and stevia.

Another embodiment of this invention is directed to the temperature-controlled release of the microencapsulated components. We have noted that certain edible materials such as dextrins, starches, and modified starches display temperature-sensitive reaction profiles (dissolution or melting). For example, starches and modified starches are generally insoluble in water at decreased temperatures (<25° C.) and become more soluble with increasing temperatures. This is opposed to the dissolution profile that is generally observed with cellulosics, in which the solubility is decreased with increasing temperature. As such, the incorporation or encapsulation of effervescent couples (e.g., acids, bases or both) wherein a starch or modified starch is used wholly or partially in the encapsulation barrier may lead to temperature-controlled release of the microcapsule components. For example, microencapsulated acid, base, or both would remain encapsulated in a chilled beverage. However, when these microcapsules are warmed (e.g., in the mouth) the effervescent components are released, thus producing the sensation of carbonation.

Examples of starches or modified starches that may be used for temperature-controlled release include those produced by National Starch & Chemical, although the starches useful in the present embodiment are not limited thereto: Advanta-Gel™ P75, Batter Bind® S, Crisp Coat UC, Crisp Film®, Crystal Gum, Crystal TeX™ 627, Crystal Tex™ 644, Crystal Tex™ 648, Elastigel™ 1000J, Encapsul 855, Flojel® 60, Flojel® 65, Flojel® G, Hi-Set® 322, Hi-Set® 377, Hi-Set® C, Hi-Set® CHG, Hylon® V, Hylon® VII, Impression™, K4484, Melojel®, Nadex™ 772, National 0280, National 814, N-TACK®, Purity® 21D, Purity® TF, Superset® LV, Ultra-Set® LT, Dry-Tack® 250, Versa-Sheen™, Baka-Plus™, Baka-Snak®, Capsul®, Capsul® TA, Gel N Melt®, H-50, Hi-Cap™ 100, Hi-Cap™ 200, IF 131, Instant ClearGel®, Instant Pure-Flo, Instant Pure-Flo F, Instant Textaid-A, Instant Textra, National 104, National 1215, National 46, National 1517, National 5730, National 711, National 78-1551, N-Creamer 46, N-Flate, N-Lite™ LP, N-LOK®, N-LOK® 1930, Novation® 4600, Novation® 5600, Novation® 9460, Purity Gum 1773, Purity Gum 2000, Purity Gum 539, Purity Gum BE, Purity® HO, Stir-N-Set® FG, Text-Aid-A®, Textra® Plus, Ultra-Crisp CS, Ultra-Sperse® 2000, Ultra-Sperse® 5, Ultra-Sperse® A, Ultra-Sperse® M, Ultra-Tex 1, Ultra-Tex 2, Ultra-Tex 2000, Ultra-Tex 3, Ultra-Tex 4, AbsorboHP, Amioca, Can-Fil®, Dry-Flo, Hoosier 5, National 150, National 1545, National 6912, National 77-1744, National 912, N-Zorbit® M, Purity® 21, Purity® 5, Purity® 825, Purity® 826, Purity® FC, Target brand tapioca, NU Mould™, Purity® 5S, Clearjel®, Clearjel® S, Colflo® 67, Firm-Tex®, Frigex® w, Hi FLO®, National 1333, National 1457, National 1658, National 4012, National 465, National 740, National Frigex, National Frigex HV, National® 320, Novation® 1600, Novation® 1900, Novation® 2300, Novation® 2600, Novation® 2700, Novation® 3300, Novation® 3600, Novation® 9230, Novation® 9260, Novation® 9270, Novation® 9330, Novation® 9360, Pure-Flo®, Purity® 270, Purity® 4, Purity® 420, Purity® 550, Purity® 660, Purity® 69, Purity® 87, Purity® Cloud, Purity® CSC, Purity® D, Purity® HPC, Purity® W, Thermflo®, Thermtex®, WNA.

The microcapsules of the invention are prepared by (i) dissolving the edible encapsulation material (e.g., polymeric or resin) in a suitable organic solvent; (ii) mixing the solubilized encapsulation material with a core material comprising an acid, a base, an effervescent couple, and/or combinations of these components; and (iii) slowly adding to the mixture, with stirring, a nonsolvent for the encapsulation material. This gives microcapsules or microparticles with a core material comprising an acid, a base, effervescent couples, and/or combinations of these components, coated with a permeable encapsulation barrier comprising a water-insoluble edible organic polymeric material that is optionally water-swellable. The terms “slowly adding” and “slow addition” refer herein to the speed of addition which results in the even distribution of encapsulation material onto the core material. Such speed of addition can be determined without undue experimentation by those skilled in the art.

The method of the present invention, as described herein, effectively deposits the desired encapsulation material onto the solids in the slurry. In addition to titration, the nonsolvent may be added via different methods known to those of skill in the art, including syringe/needle system, pipette, dropper funnel, pouring, or spraying technique. While not wishing to be bound by theory, it is believed that the solubility of the dissolved encapsulation material is slowly decreased via titration with a non-solvent. The method is most effective if the solvent and the non-solvent are miscible in each other, although this is not a requirement.

Although the addition of the nonsolvent via titration is presently preferred, the invention is not limited thereto and the method is not bound by the rate of nonsolvent addition. We have observed, however, that if the rate of nonsolvent addition is too fast, then the encapsulation material will not be evenly distributed onto the solids. Instead, large masses or aggregates will be produced. The appropriate rate of “slow addition” can be determined by those skilled in the art by general observation and without undue experimentation.

In a presently preferred embodiment, a solution of shellac in ethanol (confectioner's glaze) is combined with NaHCO₃, Mono SGC, or Di SGC, thus generating a slurry. A nonsolvent for shellac (such as diethyl ether, acetone, or the like, as is known to one skilled in the art or which could be determined without undue experimentation) is then slowly added into the slurry with stirring. Once the nonsolvent addition is complete, the ethanol and nonsolvent are decanted away. An additional aliquot of a nonsolvent (e.g., diethyl ether) is then added and the slurry is vigorously stirred. After an adequate amount of time, the solids are isolated via filtration and the solids are allowed to dry at ambient temperature.

Examples of potential solvents, nonsolvents, or any combination thereof include, but are not limited to: acetic acid, acetone, acetonitrile, acetyl acetone, acrolein, acrylonitrile, allyl alcohol, 1,3-butanediol, 1,4-butanediol, 1-butanol, 2-butanol, tert-butanol, 2-butoxyethanol, n-butyl amine, butyl dioxitol acetate, butyraldehyde, butyric acid, 2-chloroethanol, decane, diacetone alcohol, diacetyl, diethylamine, diethylene glycol diethyl ether, diethylene glycol dimethyl ether, diethylene glycol monobutyl ether, diethylene glycol monobutyl ether acetate, diethylene glycol monoethyl ether, diethylene glycol monoethyl ether acetate, diethylene glycol monomethyl ether, N,N-diethylnicotinamide, diethyl ether, dimethyl sulfoxide, N,N-dimethylacetamide, N,N-dimethylformamide, 1,4-dioxane, ethanol, 2-ethoxyethanol, 2-ethoxyethyl acetate, ethyl acetate, ethyl formate, ethylene glycol methyl ether acetate, formic acid, furfural, glycofurol, hexane, hexanes, hexylene glycol, isobutanol, isopropyl alcohol, 2,6-lutidine, methanol, methyl acetate, methyl ethyl ketone, methyl isopropyl ketone, methyl propionate, N-methylpyrrolidone, morpholine, nonane, pentane, pentanes, tert-pentanol, 2-picoline, 3-picoline, 4-picoline, piperidine, 1-propanol, 2-propanol, propionaldehyde, propylene oxide, pyridine, pyrimidine, pyrrolidine, tetrahydrofuran, tetramethylurea, triacetin, triethylene glycol, supercritical carbon dioxide, trimethyl phosphate, acetic acid isopropyl ester (isopropyl acetate), acetic acid sec-butyl ester, acetophenone, n-amyl acetate, aniline, benzaldehyde, benzene, benzophenone, benzyl alcohol, benzyl amine, benzyl benzoate, bromobenzene, bromoform, n-butyl acetate, butyric acid methyl ester, caproic acid, carbon disulfide, carbon tetrachloride, o-chloroaniline, chlorobenzene, 1-chlorobutane, chloroform, chloromethane, m-chlorophenol, m-cresol, o-cresol, cyanoethane, cyanopropane, cyclohexanol, cyclohexanone, 1,2-dibromoethane, dibromomethane, dibutyl amine, m-dichlorobenzene, o-dichlorobenzene, 1,1-dichloroethane, 1,2-dichloroethane, dichlorofluoromethane, diethyl carbonate, diethyl malonate, diethyl sulfide, diethylene glycol dibutyl ether, diisobutyl ketone, diisopropyl sulfide, dimethyl phthalate, dimethyl sulfate, dimethyl sulfide, N,N-dimethylaniline, enanthic acid, ethyl acetoacetate, ethyl benzoate, ethyl propionate, ethylbenzene, ethylene glycol monobutyl ether acetate, exxate 600, exxate 800, exxate 900, fluorobenzene, furan, hexamethylphosphoramide, 1-hexanol, n-hexyl acetate, isoamyl alcohol (3-methyl-1-butanol), isobutyl acetate, methoxybenzene, methyl amyl ketone, methyl benzoate, methyl formate, methyl isoamyl ketone, methyl isobutenyl ketone, methyl isobutyl ketone, methyl n-butyl ketone, methyl propyl ketone, 4-methyl-2-pentanol, N-methylaniline, methylene chloride, nitrobenzene, nitroethane, 1-nitropropane, 2-nitropropane, 1-octanol, 2-octanol, 1-pentanol, 3-pentanone, 2-phenylethanol, n-propyl acetate, quinoline, styrene, 1,1,2,2-tetrachloroethane, 1,1,2,2-tetrachloroethylene, toluene, 1,1,1-trichloroethane, 1,1,2-trichloroethane, 1,1,2-trichloroethylene, trifluoromethane, valeric acid, m-xylene, o-xylene, p-xylene, 2,4-xylenol or any combination of the above.

In one embodiment of the invention, the water-insoluble microcapsule coatings can be generated or modified to contain channels. We define “channel” or “channels” or “nano-channels” as holes, imperfections, or otherwise within the encapsulation barriers that allow for connectivity between the cores and the aqueous environment. The invention is not limited by the size, shape, or dimensions of these holes, imperfections, or otherwise. Water-soluble additives may be blended into the encapsulation material, and these additives may dissolve to form channels. In the case of a microencapsulated base (e.g., Mono SGC or NaHCO3), these channels would serve to slowly and controllably allow water and acid into the microcapsule, thus generating carbon dioxide (conversely, the core materials may be leached out of the microcapsule). Upon reaction, the large increase in volume that accompanies gas formation would subsequently expunge a carbon dioxide bubble from the particle. Repetition of this process results in sustained delivery of the carbon dioxide into the solution.

The microcapsules of the invention are generally characterized as a powder or as particles. When the powder or particles are added to a suitable aqueous environment, a sustained release of CO2 is observed as a result of the reaction of an acid with a base. The aqueous environment may be water or it may be a ready beverage such as non-carbonated soft drinks, non-carbonated alcoholic beverages, fruit juices, wines, and the like. A “suitable aqueous environment” is one that provides an environment that allows for the generation of CO2 when it comes into contact with the core material of the microcapsules. For example, when the core material of the microcapsules comprises a base, the aqueous environment will preferably be acidic. Alternatively, when the core comprises an acid, the aqueous environment will preferably be basic. When both an acid and a base are included in the core, or if acidic and basic microcapsules are added at the same time, additional acid or base is not necessary in the aqueous environment, although it may be present.

Other ingredients may be added to the aqueous environment to provide an enhanced organoleptic experience. For example, the addition of the powder of the present invention to a fruit drink or the addition of fruit pulp to the solids produces a “visual masking” of the microcapsules as pulp. Other additives include, but are not limited to, artificial and natural flavors, artificial and natural sweeteners, artificial and natural aroma modifiers, artificial and natural colors, modified corn starch, calcium phosphate (for use in preventing caking), artificial and natural texture additives (e.g., fruit pulp), and preservatives. Suitable additives, if not present in the core or the encapsulation barrier, can be added either prior to, during, or subsequent to the addition of the aqueous environment to the microcapsules. In one embodiment, additives may be packaged together with the microcapsules in a container, package or the like for convenience of storage and subsequent addition to an aqueous environment.

While the Examples herein focus on the microencapsulation of various core materials with various core particle sizes, this invention is not limited thereto. The particle size of the microcapsules of the invention may range from about 50 nm to about 10 mm in size. NaHCO₃ (grade TFF, from Church and Dwight) with crystalline particle sizes primarily between 20-149 μm, typically >44 μm, was employed in the Examples. Smaller particles (typically 0.5-2.0 μm with an average agglomerated crystallite size of 4-12 μm) of NaHCO₃ and KHCO₃ are known (LaJoie et al., U.S. Pat. No. 5,518,727) and may also be used. Mono SGC with particles in the size range of 2-10 μm was also utilized.

When an initial burst of CO₂ is desired immediately upon addition of the microcapsules of the invention to water, it may be necessary to add non-coated core material (e.g., NaHCO₃) and additional acid (if the core material is a base) or base (if the core material is an acid) to the water. In the absence of additional core material, the microcapsules generally exhibit a delay (for example, of from about 3-5 minutes in the absence of non-coated NaHCO₃) in order to become activated and to sustainably evolve CO₂ at an acceptable rate. Once activated, the microcapsules will sustainably deliver CO₂. By “sustainably deliver”, “sustainably evolve”, “sustainably release”, “sustained delivery”, “sustained release”, and “sustained carbonation” is meant that the microcapsules or microparticles of the invention, once activated, will deliver CO₂ for at least about 15 minutes, preferably for at least about 30 minutes, and more preferably for at least about 1 hour.

### EXAMPLES

### Example 1

### Microencapsulation of NaHCO₃ (20-150 μm) With HPC-MW=100,000

A 250 mL round bottom flask was charged with HPC-MW=100,000 (666 mg) and acetone (30 mL) and the materials were stirred until complete dissolution was observed. To this solution was added microcrystalline (20-150 μm) NaHCO₃ (2.0 g) and the slurry was vigorously stirred, followed by the dropwise addition of hexanes (50 mL) with a dropper funnel. The resultant materials were vigorously stirred at ambient temperature for 15 min and the solids were isolated by vacuum filtration. These materials were dried at ambient temperature for 2 hr, followed by further drying under reduced pressure. This protocol resulted in the isolation of HPC-MW=100,000 encapsulated microparticles which, when viewed with a microscope, were estimated to be between 20-200 μm.

### Example 2

### Microencapsulation of NaHCO₃ (20-150 μm) With HPC-MW=370,000

A 250 mL round bottom flask was charged with HPC-MW=370,000 (333 mg) and acetone (15 mL). These materials were stirred until complete dissolution was observed. To this solution was added microcrystalline (20-150 μm) NaHCO₃ (333 mg) and the slurry was vigorously stirred, followed by the dropwise addition of hexanes (100 mL) via a dropper funnel. The slurry was stirred for 10 min and the acetone/hexanes solution was decanted away. An additional aliquot of hexanes (25 mL) was added and the slurry was again stirred for 5 min, followed by isolation of the solids by vacuum filtration. The product was allowed to dry at ambient temperature for 2 hr. This protocol resulted in the isolation of HPC-MW=370,000 encapsulated microparticles which, when viewed with a microscope, were estimated to be between 20-200 μm.

The same reaction can be run with ethanol instead of acetone.

### Example 3

### Microencapsulation of NaHCO₃ (20-150 μm) With Shellac (Confectioners Glaze)

A 1 L round bottom flask was charged with microcrystalline (20-150 μm) NaHCO₃ (10.0 g), ethanol (55 mL), and a solution of shellac in ethanol (12 g, 40 wt % solids). These materials were vigorously stirred and diethyl ether (500 mL) was added via a dropper funnel. The slurry was stirred for 1 hr and then the ethanol/diethyl ether solution was decanted away. An additional aliquot of diethyl ether (200 mL) was added to the solids and the slurry was stirred for 0.5 hr. The resultant yellow solids were isolated via vacuum filtration and were allowed to dry at ambient temperature. When viewed with a microscope the individual microcapsules were estimated to be between 20-200 μm.

The same procedure may also be done with acetone, hexanes, or any other nonsolvent.

Analogous experiments were also completed with various amounts of shellac, resulting in microcapsule products in the range of 10-70 wt % shellac solids.

### Example 4

### Screen For Duration of Effervescence

A 20 mL vial was charged with a sample of the product from Example 3 (250 mg), ascorbic acid (461 mg) and NaHCO₃ (75 mg). These components were intimately blended and distilled water (20 mL at 25° C.) was added, followed by stirring for 5 seconds. This protocol resulted in a steady stream of effervescence for up to 45 minutes. When viewed from a distance, the solution appears to simply effervesce in a manner that is similar to a carbonated beverage. However, when viewed from very close it is apparent that this observation is caused by the combination of two things: 1) rising CO₂ bubbles and 2) the motion of small particles that rise when they evolve CO₂ and subsequently fall when a gas bubble detaches from them.

A control reaction was run in parallel with the above reaction. This control reaction contained microcrystalline (20-150 μm) NaHCO₃ (188 mg) and ascorbic acid (461 mg). Upon initiation of the control reaction by addition of water (20 mL), the solution vigorously bubbled and was nearly complete within 3 min., with intermittent bubbling up to 10 min.

### Example 5

### Microencapsulation of NaHCO₃ (20-150 μm) With Shellac And PEG-8000

A 250 mL round bottom flask was charged with microcrystalline (20-150 μm) NaHCO₃ (4.0 g), ethanol (22 mL), PEG-8000 (1.0 g), and a solution of shellac in ethanol (9.6 g, 40 wt % solids). The slurry was vigorously stirred and diethyl ether (100 mL) was added dropwise via a dropper funnel. The slurry was stirred for 0.5 h and the ethanol/diethyl ether solution was decanted away. An additional aliquot of diethyl ether (40 mL) was added to the solids and the slurry was stirred for 0.5 h. The resultant yellow solids were isolated via vacuum filtration and were allowed to dry at ambient temperature. When viewed with a microscope the individual microcapsules were estimated to be between 20-200 μm.

### Example 6

### Screen For Duration of Effervescence

A 20 mL vial was charged with a sample of the product from Example 5 (0.25 g), ascorbic acid (394 mg) and NaHCO₃ (75 mg). These components were intimately blended and distilled water (20 mL at 25° C.) was added, followed by stirring for 5 seconds. This protocol resulted in a steady stream of effervescence for up to 1 hr. When viewed from a distance the solution appears to simply effervesce in a manner similar to a carbonated beverage. However, when viewed from very close it is apparent that this observation is caused by the combination of two things: 1) rising CO₂ bubbles and 2) the motion of small particles that rise when they evolve CO₂ and subsequently fall when a gas bubble detaches from them.

A control reaction was run in parallel with the above reaction. This control reaction contained microcrystalline (20-150 μm) NaHCO₃ (188 mg) and ascorbic acid (394 mg). Upon initiation of the control reaction by addition of water (20 mL), the solution vigorously bubbled and was nearly complete within 3 min., with intermittent bubbling up to 10 min.

### Example 7

### Microencapsulation of NaHCO₃ (0.5-2.0 μm) With Shellac (Confectioners Glaze)

A 250 mL round bottom flask was charged with microcrystalline (0.5-2.0 μm) NaHCO₃ (1.0 g), ethanol (10 mL), and a solution of shellac in ethanol (2 mL, 40 wt % solids). These materials were vigorously stirred and diethyl ether (100 mL) was slowly added via a dropper funnel. The slurry was stirred for 1 hr and then the ethanol/diethyl ether solution was decanted away. The resultant yellow solids were isolated via vacuum filtration and were allowed to dry at ambient temperature to yield a fine and free-flowing powder. When viewed with a microscope, the individual microcapsules were estimated to be between 2-15 μm.

### Example 8

### Microencapsulation of Mono SGC With Shellac (Confectioners Glaze)

A 250 mL round bottom flask was charged with Mono SGC (2.0 g), ethanol (10 mL), and a solution of shellac in ethanol (2 mL, 40 wt % solids). This slurry was vigorously stirred and diethyl ether (100 mL) was slowly added via a dropper funnel. The slurry was stirred for 0.5 hr and then the solids were isolated via vacuum filtration. These solids were allowed to dry at ambient temperature for 2 hr, thus yielding a very fine and free-flowing powder. When viewed with a microscope, the individual microcapsules appeared to be evenly and wholly encapsulated. These microcapsules were estimated to be between 20-100 μm.

### Example 9

### Microencapsulation of Mono SGC With Shellac (Confectioners Glaze) Blended With HPC (MW=100,000)

A 250 mL round bottom flask was charged with ethanol (20 mL) and HPC-MW=100,000 (1.0 g), and the components were stirred until complete dissolution was observed. To this solution was added Mono SGC (2.0 g) and the resultant slurry was vigorously stirred, followed by the dropwise addition of diethyl ether (100 mL) from a dropper funnel. Once complete, the stirring was continued for 0.5 hr and the solids were allowed to settle. The ethanol/diethyl ether solution was decanted away and an additional aliquot of diethyl ether (40 mL) was added to the solids. The solids were stirred for 0.5 hr, isolated via filtration, and were allowed to dry at ambient temperature. When viewed with a microscope, the individual microcapsules were estimated to be between 20-200 μm.

Analogous microencapsulation experiments were conducted in which 50% and 25%, respectively, of the above amounts of HPC-MW=100,000 were employed. When screened for effervescence by reaction with an aqueous solution of citric acid, the sample containing the least amount of HPC-100,000 reacted the most vigorously. All samples effervesced for a minimum of 0.5 hr.

### Example 10

### Macroencapsulation of NaHCO₃ (20-150 μm) With Ethylcellulose Via Polymer Co-Precipitation

Macrocapsules are made by a drop-wise addition method using a syringe/needle system, pipette, dropper funnel, or spraying technique. A 250 mL round bottom flask was charged with diethyl ether (10 mL), and viscosity-4 ethylcellulose (1.0 g) was added portionwise with vigorous stirring until complete dissolution was observed. NaHCO₃ (1.0 g) was added into this polymer solution and the resultant slurry was added dropwise via a pipette into a vigorously stirred pot of hexanes (100 mL). On addition of the ethylcellulose/NaHCO₃ slurry into the hexanes, small particles immediately began to precipitate. After the addition was complete, the slurry was stirred for 10 min and the solids were isolated by filtration. These materials were allowed to dry overnight at ambient temperature and then they were further dried under reduced pressure in a vacuum oven at ambient temperature for 1 hr. In general, these particles were elongated and they varied in length from 0.25 mm to 1.0 mm.

KHCO₃, Na₂CO₃, K₂CO₃, Mono SGC, Di SGC may also be encapsulated in this manner.

Note: All of the encapsulation methods in Examples 1-10 are amenable to blending of water-soluble excipient additive materials into or onto the encapsulation material in order to allow for prolonged effervescence. This may be done by combining an additive that is soluble or insoluble into the polymer or resin solution. The additive may be a polymer, small molecule, surfactant, resin, etc.

1. A powdered beverage composition for sustained carbonation in an aqueous environment, the composition comprising a microcapsule comprising (i) a core comprising a component selected from the group consisting of acids, bases, effervescent couples, and mixtures thereof; and (ii) a water-insoluble permeable encapsulation barrier coating the core, the encapsulation barrier comprising an edible polymeric material; the microcapsule being capable of sustained release of carbon dioxide in a suitable aqueous environment.

2. A beverage composition according to claim 1 wherein the encapsulation barrier further comprises at least one water-soluble additive.

3. A beverage composition according to claim 1 wherein the encapsulation barrier is swellable in water.

4. A beverage composition according to claim 1 wherein the base is selected from the group consisting of carbonates and bicarbonates of the alkali metals and the alkaline earth metals, and hydrates thereof.

5. A beverage composition according to claim 4 wherein the base is sodium carbonate, sodium carboxy glycine, or sodium glycine carbonate.

6. A beverage composition according to claim 1 wherein the acid is selected from the group consisting of citric acid, malic acid, fumaric acid, adipic acid, aspartic acid, ascorbic acid, tartaric acid, and hydrates thereof.

7. A beverage composition according to claim 1 wherein the polymeric material exhibits a temperature-sensitive reaction profile.

8. A beverage composition according to claim 1 wherein the polymeric material is selected from the group consisting of shellac, hydroxypropyl cellulose, ethyl cellulose, polyethylene glycol, and mixtures thereof.

9. A method for preparing microcapsules capable of the sustained release of carbon dioxide in a suitable aqueous environment, the method comprising:
(i) solubilizing in a suitable solvent an encapsulation material comprising a water-insoluble edible organic polymeric material;
(ii) mixing the solubilized encapsulation material with a core material comprising a component selected from the group consisting of acids, bases, effervescent couples, and mixtures thereof; and
(iii) slowly adding to the mixture, with stirring, a nonsolvent for the encapsulation material.

10. A method according to claim 9 wherein the encapsulation material further comprises at least one water-soluble additive.

11. A method according to claim 9 wherein the base is selected from the group consisting of carbonates and bicarbonates of the alkali metals and the alkaline earth metals, and hydrates thereof.

12. A method according to claim 11 wherein the base is sodium carbonate, sodium carboxy glycine, or sodium glycine carbonate.

13. A method according to claim 9 wherein the acid is selected from the group consisting of citric acid, malic acid, fumaric acid, adipic acid, aspartic acid, ascorbic acid, tartaric acid, and hydrates thereof.

14. A method according to claim 9 wherein the polymeric material exhibits a temperature-sensitive reaction profile.

15. A method according to claim 9 wherein the polymeric material is selected from the group consisting of shellac, hydroxypropyl cellulose, ethyl cellulose, polyethylene glycol, and mixtures thereof.

16. A method for carbonating a beverage, the method comprising adding a powdered beverage composition according to claim 1 to a suitable aqueous environment, to give a beverage that exhibits a sustained release of carbon dioxide.
